(19) United States
(12) Patent Application Publication
(10) Pub. No.: US 2013/0118598 A1
(43) Pub. Date: May 16, 2013

(54) FORMATION AND BREAKING OF EMULSION USING LOW MOLECULAR WEIGHT AMINE

(71) Applicants: Xiomara Gutierrez, Caracas (VE); Raul Saud, Los Teques (VE)

(72) Inventors: Xiomara Gutierrez, Caracas (VE); Raul Saud, Los Teques (VE)

(73) Assignee: INTEVEP, S.A., Caracas (VE)

(21) Appl. No.: 13/294,468

(22) Filed: Nov. 11, 2011

(51) Int. Cl. F15D 1/00; C10M 173/00

(52) U.S. Cl. 137/13; 508/110

(57) ABSTRACT

A method for transporting a heavy crude oil, includes the steps of mixing a heavy crude oil with water, a low molecular weight amine and salt at a mixing intensity of less than 300 rpm to produce an oil in water emulsion; transporting the oil in water emulsion to a destination; and adding an additional quantity of salt and heat to the oil in water emulsion to break the emulsion and produce a heavy crude oil phase which is at least 90% dehydrated.

### BACKGROUND OF THE INVENTION

The invention relates to a method for forming and then breaking of an emulsion of heavy crude oil in water, which can be useful for transportation and handling of the heavy crude oil through pipelines and the like.

Heavy and extra-heavy crude oils have many uses once they are refined to various final products. This refining frequently requires transportation of the heavy and extra-heavy crude oil from the location of its production from a subterranean well to a plant or other facility where the refining is carried out. This transportation is typically conducted through pipelines, and the viscosity of the heavy and extra-heavy oil is such that transportation through pipelines can be difficult.

Efforts have been made to form emulsions in water of these heavy and extra-heavy crude oils, as the resulting emulsion can be easier to transport, handle, and the like. Many of these efforts result in an emulsion which is too difficult to break, or is not sufficiently stable, and the methods typically involved various different materials and steps which add to the cost of refining. Thus, the need remains for an effective method of forming and then breaking an emulsion using components which are not prohibitively expensive, and producing an emulsion which is easily transported and then broken as desired to provide the heavy crude oil at the desired location in a substantially dehydrated condition.

It is therefore a goal of the present disclosure to provide such a method.

### SUMMARY OF THE INVENTION

In accordance with the present invention, a method is provided for forming and then breaking an emulsion which addresses the issues discussed above.

According to the invention, a method is provided for transporting a heavy crude oil, comprising the steps of mixing a heavy crude oil with water, a low molecular weight amine and salt at a mixing intensity of less than 300 rpm to produce an oil in water emulsion; transporting the oil in water emulsion to a destination; and adding an additional quantity of salt and heat to the oil in water emulsion to break the emulsion and produce a heavy crude oil phase which is at least 90% dehydrated.

Utilizing the method of the present invention, an emulsion can be formed which is suitably stable for transportation through pipelines and various other handling, and the breaking step is efficiently conducted utilizing addition of heat to drive off the low molecular weight amine, and this is accompanied by the addition of more salt, the combination of which destabilizes the emulsion and provides a very clean and complete break to separate oil and water phases, wherein the oil phase comprises the heavy crude oil in a substantially dehydrated condition.

### BRIEF DESCRIPTION OF THE DRAWINGS

A detailed description of preferred embodiments of the present invention follows, with reference to the attached drawings, wherein:

FIG. 1 schematically illustrates a method according to the invention;

FIG. 2 illustrates the relationship between salt concentration and the interfacial tension in a crude oil/water system containing low molecular weight amine according to the invention;

FIG. 3 illustrates the relationship between breaking temperature and the amount of dehydration for both prior art formulations and formulations according to the invention;

FIGS. 4 and 4A illustrate an emulsion formed according to the invention; and

FIG. 5 illustrates several samples of emulsion after breaking in accordance with the present invention.

### DETAILED DESCRIPTION

The invention relates to a method for transporting a heavy crude oil which involves forming and then breaking a water in oil emulsion. In accordance with the invention, an emulsion which has suitable properties for transportation and handling can be formed from heavy and extra heavy crude oils using small quantities of low molecular weight amine and salt, and relatively low levels of mixing intensity, to produce the desired emulsion. Once the desired emulsion is handled and/or transported, and it is desired to have the heavy or extra-heavy crude oil phase separated from the emulsion, the emulsion can be broken also through a relatively simple procedure of heating the emulsion and adding an additional quantity of salt. The addition of heat serves to drive off the amine and to elevate the emulsion to a salt concentration which now destabilizes and breaks the emulsion, thereby producing separate oil and water phases wherein the oil phase is at least 90% dehydrated.

The present invention is ideally useful with any of the heavy and extra-heavy crude oils which have viscosity and/or other rheological properties which make the oil difficult to handle or transport. Typical examples of heavy and extra-heavy crude oils which can advantageously be treated in accordance with the present invention include crude oils with viscosity between 1,000 and 250,000 mPa·s. Within this range, considering for example a heavy or extra-heavy crude oil having a viscosity under normal conditions and at standard temperature and pressure of greater 50,000 mPa·s, obviously, this viscosity makes handling and transportation of the crude oil very difficult. Thus, the heavy crude oil can have a viscosity of at least 1,000 mPa·s, and the emulsion formed according to the invention exhibits a viscosity of less than 200 mPa·s

It should be noted that the viscosities of the emulsions formed are measured at 30° C. and shear from 0-120 sec⁻¹. Specific viscosity values reported were taken at 20 sec⁻¹, which corresponds generally to conditions of the crude oil moving through a pipeline.

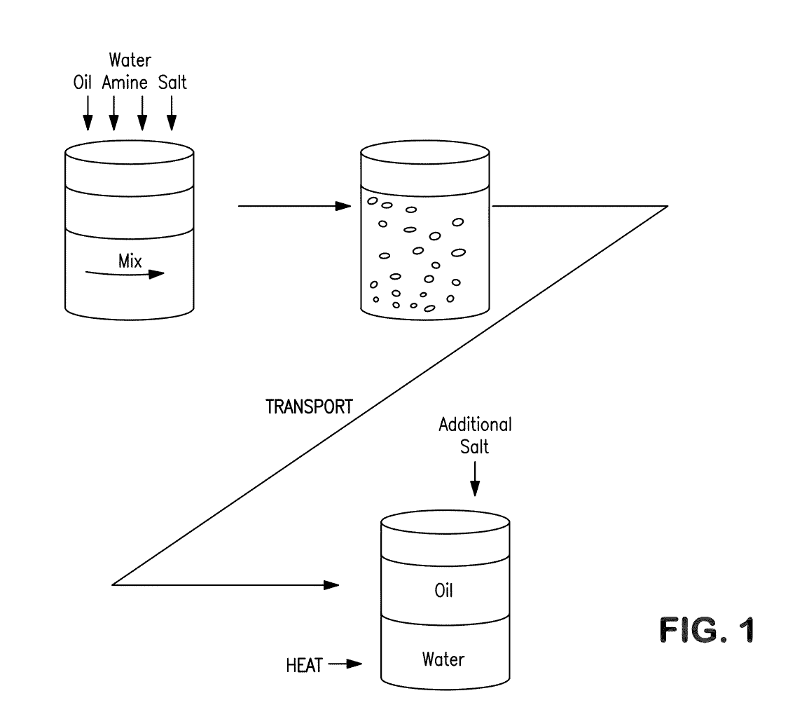

FIG. 1 schematically illustrates the method according to the invention, and shows the mixing of heavy crude oil with water, low molecular weight amine and salt, at relatively low mixing intensity and for a relatively short period of time, to produce an oil in water emulsion which is sufficiently stable for transportation to a desired destination. Still referring to FIG. 1, once that destination is reached, additional salt and heat can be added to the emulsion as shown in FIG. 1, with additional mixing, which serves to break the emulsion and produce a substantially dehydrated hydrocarbon phase as desired. The heavy crude oil can now be refined or otherwise treated at the destination, or stored at the destination as desired.

According to the invention, the low molecular weight amine is preferably an amine which is sufficiently volatile that a modest increase in temperature, for example an increase to about 50° C., will drive off the amine when it is time to break the emulsion. Of course, the amine should not evaporate at expected transportation and handling conditions. Further, the low molecular weight amine is preferably one which is readily available and not prohibitive from a cost stand-point. While various other low molecular weight amines could be used, one particularly suitable amine is ethylamine. Other suitable amines include but are not limited to propylamine, isopropylamine and diethylamine. As used herein, the term “low molecular weight amine” means amines having between 1 and 4 atoms of Carbon (c₁-c₄). Preferably, these amines have a molecular weight of less than 55 gr/mol.

The low molecular weight amine can be mixed with the oil by first preparing the low molecular weight amine in an aqueous solution, for example with some or all of the water to be added to form the emulsion. Blends of different amines may be suitable under some circumstances.

According to the invention, a relatively small concentration of an amine is effective at forming the desired emulsions. If an emulsion desired having a ratio of oil to water, by weight, of between 50/50 and 70/30, it has been found to be sufficient to utilize a concentration of amine between 250 and 750 ppm. Concentrations below 250 ppm would not likely produce a suitably stable emulsion, while concentrations above 750 ppm would not show any improvement in qualities for the cost of the additional amine.

The salt to be added during the mixing step can be any suitable supply of salt, and can preferably be NaCl, KCl or mixtures thereof. The salt can be added also in an aqueous solution, with some or all of the water to be mixed with the crude oil. This can be the same or a separate solution from the amine. It has been found as explained below that there is a window of concentration of this salt which is particularly effective at forming the desired emulsion. Once this window of concentration is exceeded, the salt instead then helps to break the emulsion. According to the invention, the preferred concentration of salt to be used during the mixing step is between 500 and 2,000 ppm, as these concentrations correspond to the general window in which the salt helps to form the desired emulsion.

Once the water, amine, salt and crude oil have been mixed, they are subjected to mixing conditions which are relatively low intensity as compared to other processes for forming emulsions. The mixing intensity is typically less than or equal to 200 rpm. Mixing can be done in a typical mixer, and the mixing is carried out for a time sufficient to produce the desired emulsion. A typical time for production of a field scale emulsion could be approximately 2 minutes.

According to the invention, the low molecular weight amine and salt serve to activate natural surfactant materials present within the crude and heavy crude oil, and this combination of natural surfactants, amine and salt serves to produce excellent conditions for formation of the desired emulsion.

It should be noted that in order to form and stabilize the emulsion, a pH greater than or equal to 11 is desired, as this pH helps to activate natural surfactants in the crude oil.

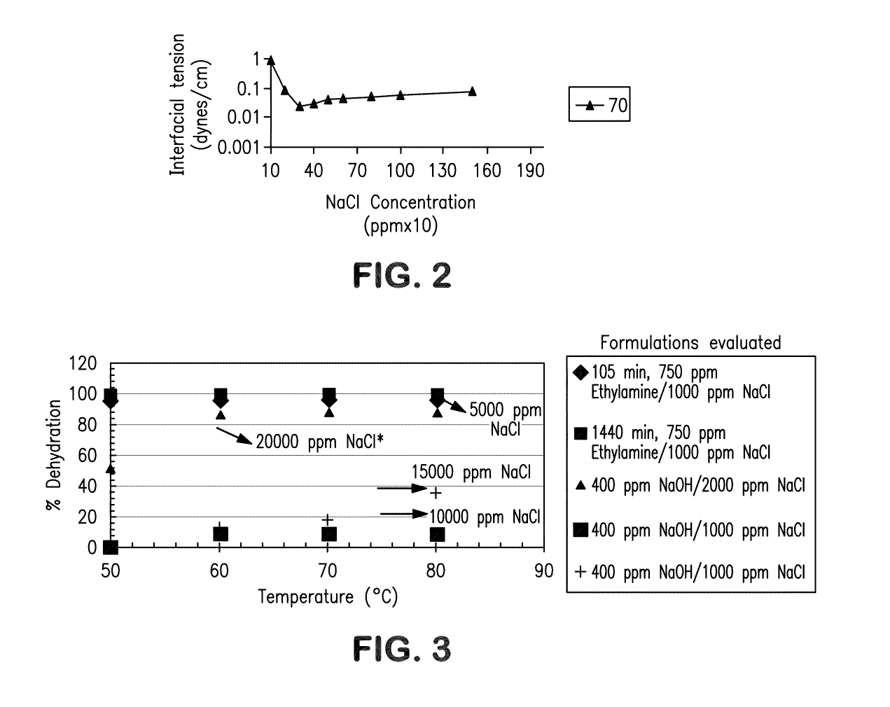

In order to evaluate the effect of salt concentration upon a crude oil/water system containing ethylamine, measurements of interfacial tension were taken at increasing concentrations of NaCl as shown in FIG. 2.

Once the heavy crude oil and water were mixed in the presence of 1,500 ppm ethylamine, measurements of interfacial tension were taken starting at a low concentration of 100 ppm and increasing up to 1,500 ppm. FIG. 2 shows that there is a band between 200 ppm and about 1,500 ppm where the interfacial tension remains between 0.01 and 0.1 dynes/cm. These values are ideal for the formation of an emulsion according to the invention.

The resulting emulsion formed according to the invention has suitable properties for transportation and handling through typical pipelines and other equipment. One method of determining the stability of such an emulsion is to measure the static stability as represented by viscosity and mean droplet diameter over periods of storage time. Emulsions were prepared according to the invention using 750 ppm ethylamine and 1,000 ppm NaCl. Crude oil/water emulsions were formed having a ratio of crude oil to water of 50/50 and 60/40. These two emulsions where then evaluated over a storage time of eight days at a temperature of 40° C., with measurements of mean droplet diameter and viscosity being taken at various points along this storage time.

Emulsions formed according to the invention typically have an average droplet size of between 5 and 22 microns, and a viscosity of between 15 and 200 mPa·s.

Table 1 below sets forth the results of these measurements, and it should be appreciated that the droplet diameter and viscosity changes over this period of storage are perfectly suitable for an emulsion being formed for the purposes of transportation and handling of heavy and extra-heavy crude oils. This is particularly true when keeping in mind that the beginning heavy crude oil had a viscosity of about 50,000 mPa·s, and that the emulsion had a viscosity of between 30 and 200 mPa·s or cP as presented in Table 1.

TABLE 1

| | | |
|---|---|---|
| | Mean droplet | |
| | diameter (micron) | Viscosity (cP) |
| Storage time | Crude oil/ | Crude oil/ |
| (days) | water ratio (w/w) | water ratio (w/w) |

| T: 40° C. | 50/50 | 60/40 | 50/50 | 60/40 |
|---|---|---|---|---|
| 0 | 12.25 | 20.75 | 16.32 | 37.3 |
| 1 | 12.56 | 23.50 | 16.74 | 38.0 |
| 2 | 13.50 | 21.82 | 18.81 | 35.43 |
| 4 | 13.86 | 21.50 | 19.0 | 33.0 |
| 8 | 13.92 | 22.62 | 20.21 | 39.0 |

A further beneficial aspect of the present invention is to cleanly and efficiently break the emulsion when it is desired to do so, for example when the emulsion has reached a destination where the heavy crude oil is to be used, stored or treated. In order to break the emulsion according to the invention, the emulsion is heated to a temperature of between about 50 and about 70° C., and additional salt is added to increase the salt concentration above the upper limit of the window in which a stable emulsion was formed. The increase in temperature helps to break the emulsion by causing the low molecular weight amine to evaporate out of the emulsion. This serves to inactivate the natural surfactants which had been activated to form the emulsion. In addition, the increase in salt content further increases the interfacial tension between the oil and water phases, and under these conditions the emulsion breaks and hydrocarbon dehydrates relatively quickly. Excellent dehydration can be accomplished by increasing the salt concentration to greater than or equal to 5,000 ppm at the described temperatures, and preferably under a mixing intensity of 200 rpm for a period of two minutes. The broken emulsion then generates a heavy crude oil phase and a water phase, and the heavy crude oil can readily be brought to a state of dehydration of between 98 and 100%. The effectiveness of breaking of the emulsion is brought about by the synergistic combination of mixing intensity, salt concentration, temperature and volatility of the amine used to form the emulsion.

In order to further demonstrate the effectiveness of breaking according to the invention, five formulations were evaluated for the relationship between temperature and percent dehydration. Three of these formulations were emulsions that had been formed using NaOH, and then were attempted to be broken utilizing different concentrations of NaCl. The other two formulations evaluated were emulsions which had been formed with 750 ppm ethylamine and which were formed with 1,000 ppm NaCl. FIG. 3 shows the results. As shown, of the three formulations evaluated that used NaOH, the formulation which utilized 2,000 ppm NaCl produced the best dehydration of this group, and those results are not particularly satisfactory. It is noted that even at a temperature of 80° C., the 400 ppm NaOH/2,000 ppm NaCl formulation had still not reached a level of dehydration of 90%. The other formulations formed with NaOH produced results far less satisfactory. Further, the NaOH/NaCl formulations required much more additional salt even to reach the poor results shown. Specifically, the ethylamine/NaCl formulations according to the invention required 5,000 ppm of additional NaCl, while the NaOH/NaCl formulations required 10,000, 15,000 and 20,000 ppm.

On the other hand, considering the formulations evaluated in accordance with the present invention, the ethylamine and NaCl combination produced approximately 98% dehydration after 105 minutes, and 100% dehydration after 1,440 minutes, and these results were consistent at temperatures of 50° C., 60° C., 70° C. and 80° C. It has been found crucial in accordance with the present invention to properly interact the natural surfactants in the heavy crude oil with the NaCl salt, to which the natural surfactants are very sensitive. This is the basis for the amounts of NaCl salt which are used to form the emulsion and which are then subsequently used to break the emulsion. While general numbers are provided herein for the amounts of NaCl salt which are suitable for these purposes, exact amounts for a particular heavy crude oil can be determined by obtaining a sample and testing the heavy crude oil to determine the window of effectiveness of the particular natural surfactants contained within the heavy crude oil.

A further key point to understanding the present invention is the use of an amine having a suitably low evaporation temperature such that the volatility of this amine allows a reasonable increase in temperature to drive off the amine when desired, and a sufficiently high evaporation temperature that the amine is not driven off during the desired transportation and handling of the emulsion. This alters the acid-base equilibrium which is required to maintain a stable emulsion, and therefore the heating of the emulsion helps to break the emulsion when desired.

It should also be appreciated that the mixing intensity used in accordance with the present invention is effective at low mixing intensities because these intensities are sufficient to promote contact between the dispersed drops of crude oil and the solution of amine and NaCl. Further, the mixing during breaking of the emulsion can also be accomplished at low mixing intensities because all that is needed is for the additional salt to contact the crude oil and, particularly, the droplet interface containing any remaining amine and/or activated natural surfactants, and this helps to bring about the rapid breaking of the emulsion.

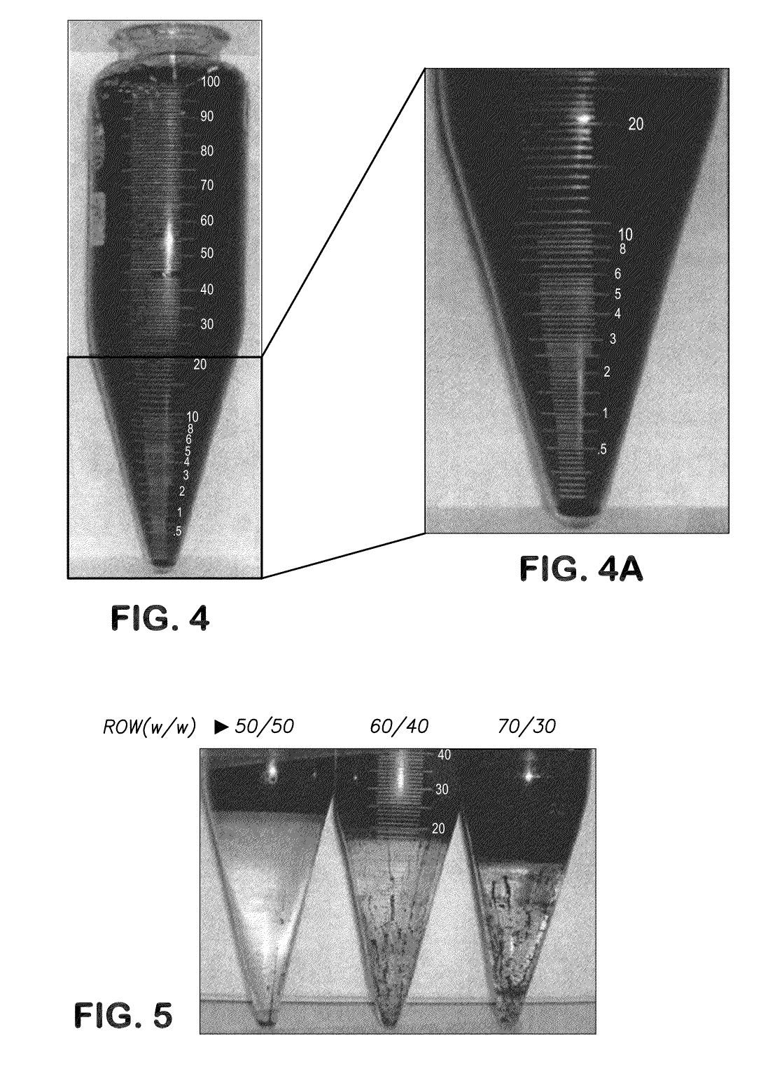

Samples of emulsions formed according to the invention were obtained, and FIGS. 4 and 4A show photographic images of these samples. The test vessel is filled with a substantially homogeneous emulsion of crude oil and water as desired. Three sample emulsions ere prepared having ratios (w/w) of oil to water of 50/50, 60/40 and 70/30. The samples were then heated to 80° C., and the salt content was increased to 0.5% (5,000 ppm). FIG. 5 shows photographs of these three emulsions after the breaking steps according to the invention, and show a very clean break between the phases. Further, Table 2 below contains the actual dehydration or water separation results for each of these emulsions, and shows separation percentages of 99, 96 and 94% for the three emulsions evaluated.

TABLE 2

| ROW | | % H₂O |
|---|---|---|
| (w/w) | % NaCl | Separated |
| 50/50 | 0.5 | 99 |
| 60/40 | 0.5 | 96 |
| 70/30 | 0.5 | 94 |

It should be appreciated that the above description is given in terms of various preferred embodiments of the present invention. These embodiments are given for the sake of illustration and to help in understanding the present disclosure. The scope of the present invention is not to be seen as being limited by these embodiments, however. Rather, the scope of the invention is to be defined by the claims appended hereto and their equivalents.

1. A method for transporting a heavy crude oil, comprising the steps of:
mixing a heavy crude oil with water, a low molecular weight amine and salt at a mixing intensity of less than 300 rpm to produce an oil in water emulsion;
transporting the oil in water emulsion to a destination; and
adding an additional quantity of salt and heat to the oil in water emulsion to break the emulsion and produce a heavy crude oil phase which is at least 90% dehydrated.

2. The method of claim 1, wherein the heavy crude oil has a viscosity of at least 1,000 mPa·s and the oil in water emulsion has a viscosity of less than 200 mPa·s.

3. The method of claim 1, wherein the heavy crude oil contains natural surfactants which, in the presence of the amine and salt, reduce interfacial tension of the heavy crude oil and the water so as to form the oil in water emulsion.

4. The method of claim 1, wherein the low molecular weight amine has a molecular weight less than 55 gr/mol.

5. The method of claim 1, wherein low molecular weight amine is ethylamine.

6. The method of claim 1, wherein the salt is NaCl.

7. The method of claim 1, wherein the mixing and transporting step is carried out at a temperature of less than or equal to 40° C., and wherein the adding step comprises heating the oil in water emulsion to a temperature of at least 50° C.

8. The method of claim 1, wherein the amine is driven off by the heat added in the adding step so as to inactivate natural surfactants from the heavy crude oil and break the emulsion.

9. The method of claim 1, wherein the amine is mixed in an amount between 250 and 750 ppm.

10. The method of claim 1, wherein the heavy crude oil and the water are mixed to produce an oil in water emulsion having a ratio by weight of oil to water of between 50/50 and 70/30.

11. The method of claim 1, wherein the heavy crude oil phase is at least 98% dehydrated.

12. The method of claim 1, wherein the salt is mixed in an amount between 500 ppm and 2,000 ppm.

13. The method of claim 1, wherein the additional quantity of salt is added so as to raise the salt concentration in the emulsion to at least about 5,000 ppm.

14. An oil in water emulsion suitable for transportation through fluid pipelines comprising:
a heavy crude oil phase, a water phase, a low molecular weight amine and a salt, wherein the emulsion has a viscosity of less than 200 mPa·s.

15. The emulsion of claim 14, wherein the emulsion has an average droplet size of between 5 and 22 microns, and a viscosity between 15 and 200 mPa·s.
